(19) United States
(12) Patent Application Publication
(10) Pub. No.: US 2007/0261109 A1
(43) Pub. Date: Nov. 8, 2007

(54) AUTHENTICATION SYSTEM, SUCH AS AN AUTHENTICATION SYSTEM FOR CHILDREN AND TEENAGERS

(76) Inventors: Martin Renaud, Maple Ridge (CA); Reh Mulji, Calgary (CA)

Correspondence Address: PERKINS COIE LLP;PATENT-SEA, P.O. BOX 1247, SEATTLE, WA, 98111-1247, US

(21) Appl. No.: 11/693,438

(22) Filed: Mar. 29, 2007

Related U.S. Application Data
(60) Provisional application No. 60/797,718, filed on May 4, 2006.

(51) Int. Cl. H04L 9/32

(52) U.S. Cl. 726/6

(57) ABSTRACT

An authentication or security system can provide multiple categories to user (e.g., a young user), where at least one of the categories does not relate to an experience to be recalled by the user, but relates to one or more fictional stories, fictional narratives, historical stories, fictional locations, fictional constructs, fictional characters (e.g. avatars) etc., and the user selects a category and answers several questions to personalize the story/construct/etc. Received data for this personalization is then stored in an authorization profile that is later used to authenticate the user. Other features and aspects are also disclosed.

### CROSS REFERENCE TO RELATED APPLICATION(S)

This application is related to U.S. patent application Ser. No. 11/608,186, filed 7 Dec. 2006, entitled “AUTHENTICATION SYSTEM EMPLOYING USER MEMORIES”, and is referenced below by the acronym “PROM” (Presence of Mind authentication system).

This application is also related to U.S. Provisional Patent Application No. 60/797,718, filed 4 May 2006, entitled “SYSTEM AND METHOD OF ENHANCING USER AUTHENTICATION THROUGH ESTIMATION OF FUTURE RESPONSE PATTERNS”, and is referenced below by the term “Mindseye”.

### BACKGROUND

The Internet is used by people of all ages, with children representing a large and growing segment of the user population. This results in children being increasingly exposed to both security threats and questionable online content. For example, some of the threats involve vulnerability to sexual predators who, capitalizing on the anonymity offered by chat rooms and other social networking sites, intentionally proposition unsuspecting young people.

With increased usage and growth across the world wide web (WWW), it is clear that online content and security threats will also increase; yet, while children require protection from such threats, they also lack the experience with which to adequately guide their online activities. As a result, children can be susceptible to predators, exploitation, identity theft, and fraud. Hence there is a need for safe and reliable authentication that fully accounts for factors related to age and experience. Current authentication systems are inadequate to these needs.

Currently, username/password entry requirements remain the predominant security restriction on most internet sites. While second factor mechanisms have been implemented by some online sites, these too are not designed to provide easy, efficient, and effective use by children. For example, one of the general problems with passwords is that users often create a code that is easily guessed, and children are even less likely than adults to use the random-pattern characters that reduce the success of “guessing” attacks. Children are also more likely to share their password with friends and family, which severely decreases password security. Password management techniques (such as regularly changing their passwords and using a unique password for every site) are, despite regular warnings, routinely ignored by adults; children cannot be expected to understand the importance of such strategies, and are even less likely to use them. Other second-factor methods may involve privacy issues; for example, parents may not want biometrics information (such as fingerprinting) recorded about their children. There is a need, then, for an authentication system that does not require ongoing training, is able to securely manage authentication for children, and is both fun and simple to use. Children need a security system that is designed specifically for their needs.

Many authentication problems are the result of either poor education and/or poor design, and can frustrate adult users; if children experience similar frustration and confusion with systems not designed to meet their needs, then they will likely form a negative attitude towards security as they grow into adulthood. By designing authentication systems to meet children's needs as their abilities grow, a more positive attitude towards internet security can result. Therefore, an authentication system is required that is fun, easy, effective, and adaptable in real time to growth in internet experience and cognitive abilities. In addition, a suitable system should not be compromised by theft, sharing, recording, (written or otherwise) or forgetting.

In addition, a properly designed child authentication system would alert system administrators to any adult attempt at entering child accounts, so that authorities can be quickly alerted. This would reduce vulnerability to online child predators, an activity that often involves online impersonation of children by adults. A well-designed child authentication system would detect and discourage such impersonation.

A well-designed login and authentication system for children would also create opportunities for government, businesses, and educators to offer services that, due to security issues, may not have been viable before. As particularly vulnerable consumers of information products and services, and as the future primary consumers, children need an adaptable, effective, and secure authentication system that allows them to harness the full potential of the electronic and information age.

### BRIEF DESCRIPTION OF THE DRAWINGS

FIG. 1 is a block diagram of a computer that may employ aspects of an authentication system.

FIG. 2 is a block diagram illustrating a computing system in which aspects of the authentication system may operate in a networked environment.

FIGS. 3A, 3B, 4A, 4B and 4C are representative display screens of one embodiment of the invention.

FIGS. 5-10 are representative display screens of an alternative embodiment.

FIG. 11 is a flowchart diagram illustrating suitable steps performed under an authentication routine.

FIG. 12 is a flowchart diagram illustrating suitable steps performed under a profile evolution routine.

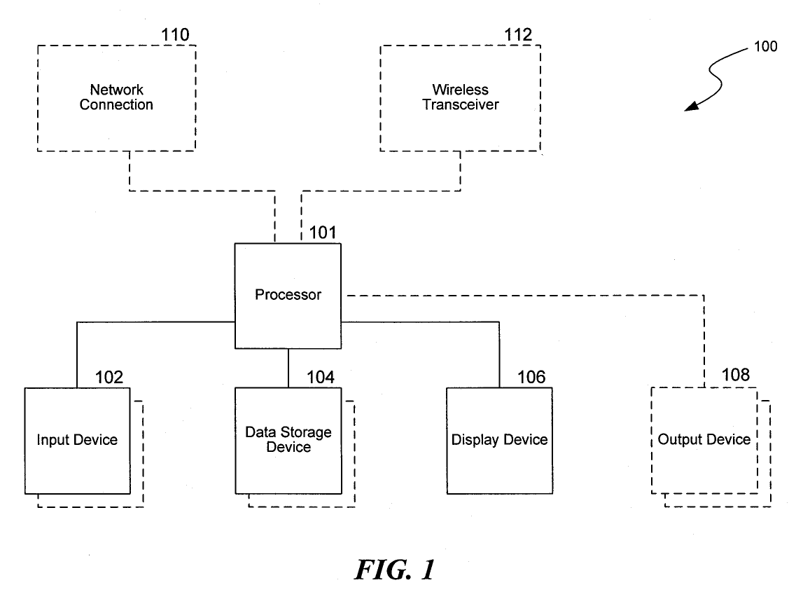

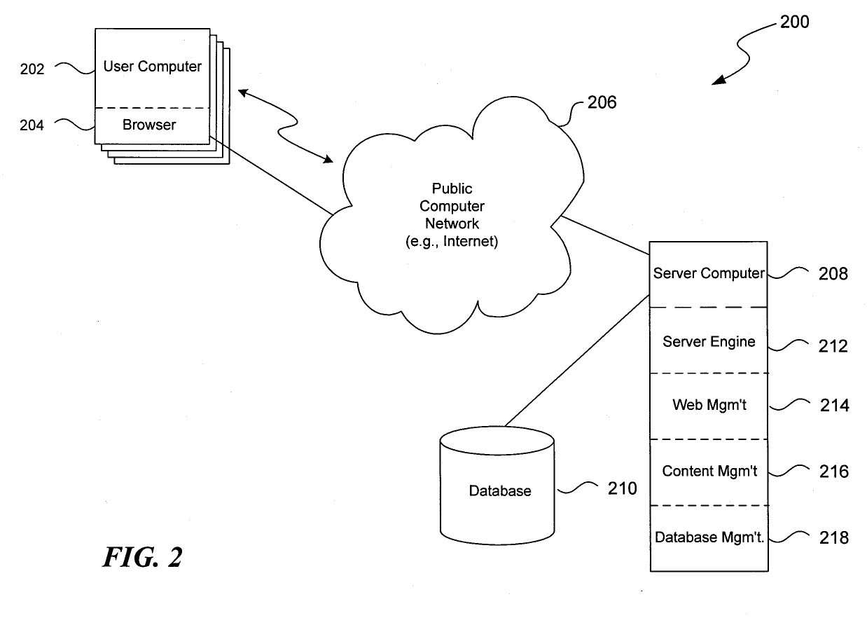

### DETAILED DESCRIPTION

Online security has recently begun to improve, with authentication systems like PROM offering significantly better performance for adults; however, a system does not yet exist that provides the hallmark characteristics of PROM (increased reliability, easy to use, and addresses concerns regarding password hacking, password sharing, and password management) to young online users. The system described below builds on the success of PROM to provide easy to use, secure and fast authentication for children.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

### I. Representative Computing Environment

The following discussion provides a general description of a suitable computing environment or system in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

The invention employs at least one computer 100, such as a personal computer or workstation, with at least one processor 101, and is coupled to one or more user input devices 102 and data storage devices 104. The computer is also coupled to at least one output device such as a display device 106, and may be coupled to one or more optional additional output devices 108 (e.g., printer, plotter, speakers, tactile or olfactory output devices, etc.). The computer may be coupled to external computers, such as via an optional network connection 110, a wireless transceiver 112, or both.

The input devices may include a keyboard and/or a pointing device such as a mouse. Other input devices are possible such as a microphone, joystick, pen, game pad, scanner, digital camera, video camera, and the like. The data storage devices may include any type of computer-readable media that can store data accessible by the computer, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet. As will become apparent below, aspects of the invention may be applied to any data processing device. For example, a mobile phone may be secured with only the addition of software stored within the device—no additional hardware is required. The software may be stored within non-volatile memory of the phone, possibly even within the subscriber identity module (SIM) of the phone, or stored within the wireless network.

Aspects of the invention may be practiced in a variety of other computing environments. For example, a distributed computing environment including one or more user computers 202 in a system, each of which includes a browser module 204. Computers may access and exchange data over a computer network 206, including over the Internet with web sites within the World Wide Web. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. Web browsers, or any application program for providing a graphical or other user interface to users, may be employed.

At least one server computer 208, coupled to a network, performs much or all of the functions for receiving, routing and storing of electronic messages, such as web pages, audio signals, and electronic images. Public networks or a private network (such as an intranet) may be preferred in some applications. The network may have a client-server architecture, in which a computer is dedicated to serving other client computers, or it may have other architectures such as a peer-to-peer, in which one or more computers serve simultaneously as servers and clients. A database 210 or other storage area coupled to the server computer(s) stores much of the web pages and content exchanged with the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer may include a server engine 212, a web page management component 214, a content management component 216, and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component handles storage and retrieval tasks with respect to the database, queries to the database, and storage of data such as video, graphics and audio signals.

### II. Suitable Implementation and Overview

The system (sometimes referred to as Little Bo Peep, or LBP) capitalizes on the effect creativity has on memory. In most embodiments, users are first asked to choose a theme or story, and then to modify that story using a number of unusual and creative ideas (referred to as “options” in this document) that they select from a list. The nature of these options spontaneously generates vivid mental images, which provide a fun and memorable experience both during the “initiation” and steady-state “authentication” phases. Embodiments that start with familiar characters and plots from well-known stories (such as fairy tales), and then introduce distinct new characters (offered as choices by the system), are optimal for children to use as part of their authentication system—they're easy, interesting, and fun.

LBP also capitalizes on the security and usability of PROM authentication, but is specifically designed to meet the needs of child authentication. PROM authenticates by asking users to display knowledge of their past experiences or events, and is designed primarily for adults. In contrast, LBP is designed for the segment of the population who are not old enough to have a broad set of life experiences to draw on, and who are less likely to engage in nostalgia. Instead of concentrating on past experiences, one embodiment of LBP asks its users to develop variations on well known stories and creative activities, and then to use their memory of these unique variations for subsequent authentication. The PROM system is used as a template that provides high levels of security to the technology, while themes of the stories and activities in this system are specifically designed for easy use by children. The theme selection mechanism enables the system to evolve, so that it effectively “ages” with the child; this process continues as an individual approaches adulthood, with the system gradually replacing LBP characteristics with those of the adult-oriented PROM.

In normal, steady-state use, the system performs three main tasks: it presents a graphical user interface to capture information related to the memories of the user (Initialization Phase); it records multiple forms of information used to assess the validity of an identity claim (Authentication Phase); and it evolves each user's authentication profile over time to mimic a specific individual's changing mental age (Profile Evolution). These three components integrate with each other to provide an easy, fun, and interactive user experience. Verification of an identity claim can be based on accurate replication of details in a user's profile, and by sending information about a rate of entering those details into a cognitive analysis engine (like MindsEye, noted above). In addition, the type of information and rate of data entry may be subjected to an age regression component, which can produce an estimate of the user's mental age. This allows for a comparison of current mental age with the user's previous mental age, which can then serve numerous purposes (including enhancing authentication accuracy and identifying adult imposters and predators).

In addition, some embodiments may use this child-centered technology and apply it to specific adult-oriented requirements. An example might be authentication systems for low-functioning adults who find difficulty with standard adult-oriented authentication systems. Another embodiment may be directed towards persons with medical or age-related difficulties that make standard password systems unsatisfactory.

Adults will be less able to use this technology for the purposes of authentication than children because they will likely experience more interference between thematic details. One cause of forgetting in normally functioning humans is the overlap of remembered details between similar experiences which results in forgetting. For example, the experience of forgetting whether the main door was locked or not before exiting one's home results from interference between the event in question and all previous times when the home was locked on departure—the similarity of the details of the differently timed events blend and cause confusion. Adults would be susceptible to the same confusion between a version of the story they create during the authentication event and all previous versions that they experienced during their life. In addition, adults have extensive experience modifying narratives in memory to be consistent with what they already know. This habitual reconstruction process is not under conscious control, so adults will feel like they are remembering vertically, despite entering different details than those that they originally entered. Children, on the other hand, are not yet habituated to this process. Their reduced experience with each of the themes in LBP makes them less likely to suffer interference and forgetting.

### III. Initialization Phase

Before an individual user can engage in normal, steady-state use of the system, that user first completes an initialization phase. Initialization occurs after a new user enters an identity claim (such as a username and password login). The initialization phase allows the user to learn about the system by viewing a selection of potential themes stored in a database.

In one embodiment of the current invention, the initialization phase captures users' input regarding stories; the user is required to choose one story from a list of story titles, and then to modify details of the story to create a new and unique version. For example, users will replace existing details pertaining to characters, places, and plots, with new details chosen from a list of potential options. The choice of stories will include age-appropriate themes, such as fairy tales, adventures, historical stories, westerns, and fantasies—specific examples could include “Cinderella,” “Build a city,” or “Tom Thumb”. The rest of the initialization procedure allows a user to develop the chosen theme by either replacing details of the story (Cinderella married a PRINCE can be changed to Cinderella married a MONKEY), adding details to the theme (every corner of the city has a . . . CASTLE, etc) or completing some other form of task.

Themes and corresponding stories may be randomly presented from a database, or may be presented based on characteristics of the user or system. The database consists of system-operated, system-produced, and empirically tested themes and stories. More themes and stories may be added to the database when required (see below).

The stories offered to the user may be familiar or completely novel, while options for both queries and potential answers (regarding the chosen story) may be represented as questions or statements in lists. Options may be presented in a columnar grid, a vertical grid or a circular format, where each option corresponds to a queried detail.

Users require no training prior to initialization, since the user is guided at each step in the process by qualifying questions or statements. The qualifiers prompt the user in correct usage of options being displayed. One embodiment of the invention may consist of close-ended qualifying statements in which each contains a word or concept representative of a detail from the chosen story. The qualifiers guide the user through the process of replacing the key words or concepts with options from the available list. Another embodiment may consist of open-ended questions about details; in this case, qualifying questions ask the user about specific details in the story, again referring to a list of potential replacements.

After selecting the required number of new details for the chosen story, the user may be required to provide one or more words in response to a final question about a particular aspect of that story. For example, the user may be asked to provide a response to the query “Change RED in Little Red Riding Hood to a different color.” The question is designed to prompt an unusual and unique memory association, which may be required in future authentication: the system may require the user to recall and provide the word or words originally entered in this final step of the initialization phase.

At the end of the initialization process, users may be reminded about the selections they've made; hence users can verify their selections and strengthen their memory of the theme they've just created. Following this verification step, the user may be required to re-enter the selections chosen for that theme. This additional “training” phase is designed to enhance the user's confidence in using the required information for that theme. The training phase will also verify the user's ability to replicate the previously entered information, thereby enhancing security.

User responses—specifically, the selection of new details for a chosen story—are used by the system to create a unique user profile. The responses form the “knowledge” portion of the user profile stored by the system, and act as a comparison template for future authentication attempts. In addition, rates of data selection are also recorded at each step, and are added to the user's profile.

Some embodiments may require multiple stories to be covered by each user in the initialization process, either as a normal requirement or on an as-needed basis; in the latter case, security can be enhanced as desired by either system manager or user. Accordingly, the user may periodically be required to add additional themes to his/her profile, from which the new additional stories can be chosen. To the user, this process of adding additional themes/stories would highly resemble the initialization phase. These “extra” initiations enhance security by limiting predictability of the authentication process—even the user will not know which story will be queried until the authentication event begins—and lower predictability makes intrusion more difficult.

Additionally, some embodiments may use all of the details, or some combination of details obtained during the initialization phase for the purpose of creating a fictional computer-generated character, such as a memorable avatar personalized for the user. As the user adds in details of the story or theme, those details can be displayed on an authentication avatar. Subsequent initialization could add new details like hair colour, specific clothing style, or items or gestures to this authentication avatar. The avatar therefore acts as an active cartoon creation of the user.

### IV. Authentication Phase

Future authentication attempts present users with the same queries as they saw in the Initialization phase, with successful authentication being achieved when the same corresponding options are again chosen from a set of distracters (distracters are options that were not selected during initialization). Dependent on the need for security, the number of details queried for a story in a user's profile may vary. At any time during the authentication phase, the user may request help through an icon shown in the display. Visual (e.g., textual, video) or audio feedback may be provided as an aid.

In the example above that uses an avatar, users can be prompted to complete their avatars with the details of their previous creations. This would also facilitate easy and fast addition of details, potentially at each and every authentication event. Various user interface techniques and display screens may be used to implement this, such as question and answer, drag and drop, etc.

Upon completion of the recognition phase, users may be presented with feedback on their performance. The feedback shown after a successful authentication includes the reward of accessing the desired account. The user could also experience a brief audio or visual reward (e.g., a funny joke presented in a short visual clip, a pop up animated character, etc.) This type of reward can sponsor positive reinforcement for successful authentication, as well as act as a fun reward for using the system effectively. In the case of an unsuccessful authentication, a visually uninteresting prompt is provided, and the user may be permitted to try again. Using an unappealing & uninteresting prompt for unsuccessful authentication reduces the amount of reinforcement that might inadvertently associate with a true user's error in memory, which in turn helps to protect that user's accurate memories from confusing interference.

### V. Profile Evolution Phase

Individual user profiles in the system are dynamic, evolving through time to reflect the changing mental age of each user. One method of development is to make old stories unavailable for authentication, while new, age-appropriate themes are added to the user's profile. For example, if the current estimated age of the user is markedly different from that estimated at the time of the last initialization, then more complex themes may then become available, and the user is asked to engage in a short re-initialization. The more simple themes in the profile may be removed at this time, and replaced with more age-appropriate ones. Once the estimated mental age reaches a certain point, the system begins to add PROM events to the set of potential themes. These periodic boosts in security constitute a gradual process that ultimately results in the system converting the user profile from LBP to PROM, all without user intervention or disruption with login performance. Thus with maturity the user's LBP profile gradually develops towards the use of life events instead of stories.

Different versions of the themes in the initialization selection lists are stored in the database, and reflect different mental age levels. For example, the “Build a City” theme will have options like “house” and “barn” for young children, but “skyscraper” and “pyramid” for older children. The wording of the themes, therefore, can be varied to promote easy and fast understanding for different age levels.

The input collected by the system may include users' theme-related selections, their theme-related whole word responses, their reaction times, mouse paths, impact points (e.g., x-y coordinates of where a mouse click is made), and other user-controlled input data. The system may output accuracy measures, reaction times, mouse path and impact information, and any other information that has been gathered, to an external analyzer (e.g. Mindseye, noted above). In addition, the current system compares performance on a given theme to a pre-calculated set of age regression parameters to output an estimated mental age of the user. (For example, younger children may take longer to respond and select the appropriate response to a given question than older children.)

The age regression parameters can be created through a number of standard regression equations. For example, one embodiment may use data from a test group of varying ages in order to create a set of regression parameters; these parameters allow comparison between rates of selecting theme details, age-levels of themes (e.g., theme complexity), and the known ages of the test participants. Thus, empirical data may be gathered through, e.g., testing of users of known ages to gather sufficient user-controlled input data to create regression parameters for different age categories (e.g., 5-7 year olds, 8-10 year olds, etc.) These regression parameters can remain current, via regular updates with data from new test subjects. The parameters can be implanted within the LBP process—as a standard set of equations that use current response rates and theme type as input, and produce age estimates as an output. The age estimates can then be subjected to a set of administrative decision rules, which will govern the production of warning flags for system administrators, etc.

The regression equations can be coded as part of the authentication software, or form a separate software component that takes provided input and outputs a probability of belonging to certain age groups. Thus, this software component may be set by an administrator to provide a probable age, or to provide a flag for any user who fails to meet a set age threshold. The set age threshold or initial age group can be preset by client specific rules. For example, a site can choose to ask users for their age. Many sites already do this, although currently this provides untrustworthy data since the site has no means of checking the truth of the age provided to the system. It could leave this as optional in the situation of a user has been referred to the site by a friend (assuming that the friend belongs to a similar age group.) Most systems do not need to have an accurate age measure. Instead, they need to be able to differentiate certain age groups (usually for legal or ethical reasons). An adult site, for example, can preset the age criteria as “adult”. The regression equations can be used to determine the probability that the user belongs to this age group. Similarly, a teen site can set the age criterion to “teen”. The system or software component may employ separate regression equation beta parameters for each relevant age grouping. The equations would then forward the probability of belonging to the age group to the administrator of the site. The site can then apply decision rules based on this probability.

Rules can be constructed to use the probability assessment produced by the regression equations to meet specific age-related goals. For example, a high probability of belonging to a required age group (i.e., “teen group” for a teen only site) could result in no further action, and grant immediate access to all information on the site. A low probability result, on the other hand, could result in additional tests of age appropriateness. These additional tests could include requesting that the user enter their age, or asking the user for additional personal information prior to granting access. It could even involve a personal telephone follow-up to determine if the user is who they claim to be. Additionally, the user's account may be allowed limited access to some of the accounts' resources and given an administrator flag or warning of potential age violation. This would enable enhanced monitoring of questionable accounts and possibly anticipate user abuse of privileges or inappropriate behavior. For example, the site could request credit card information.

The age-regression equations enable dynamic, automatic evolution of the user's authentication profile. As a user evolves from child to teen to adult, the profile evolves by addition of new age appropriate stimuli and subtraction of less recent, more youthful oriented stimuli. The timing of these changes can be integrated with a permanent schedule of stimuli additions under the authentication process. Users, therefore, would be told from the first enrolment that periodic additions to their profile will be requested to strengthen the security of their account. A variable schedule can be constructed for the user's account for the timing of additions to their profile. When the schedule indicates that it is time to add an event, the system can call the age-regression result to determine if the type of stimulus added should be older than those currently in the profile. If the profile is of a suitable length, then a single, less appropriate or older event/theme can be removed from the profile. Over time, and without user intervention, the profile will adjust to stay synchronized with the aging of the user.

### VI. Example of Initialization and Authentication Phases

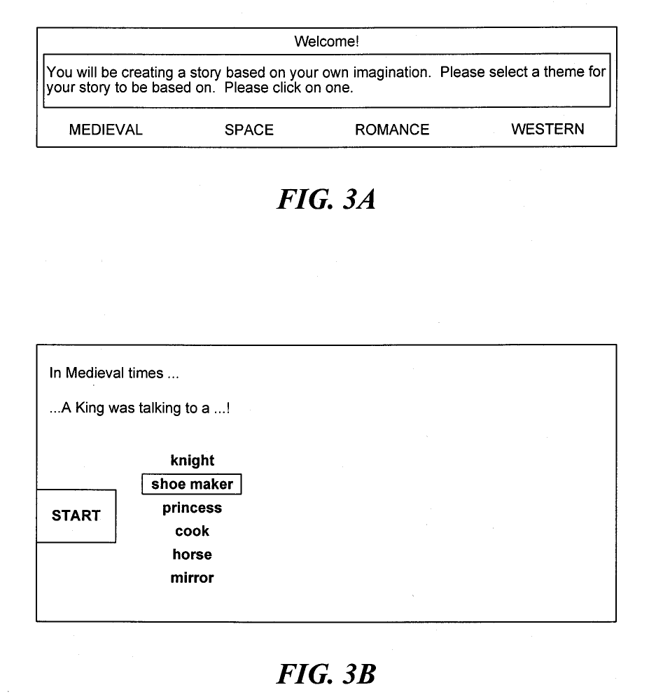

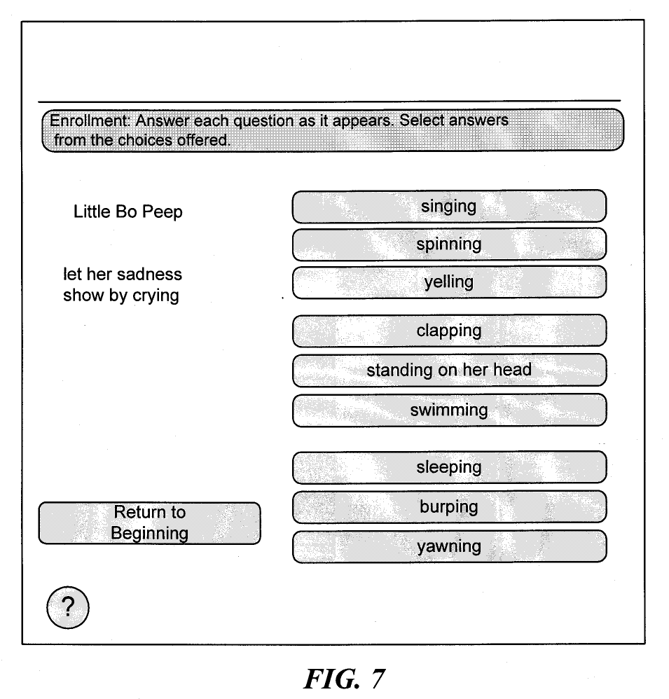

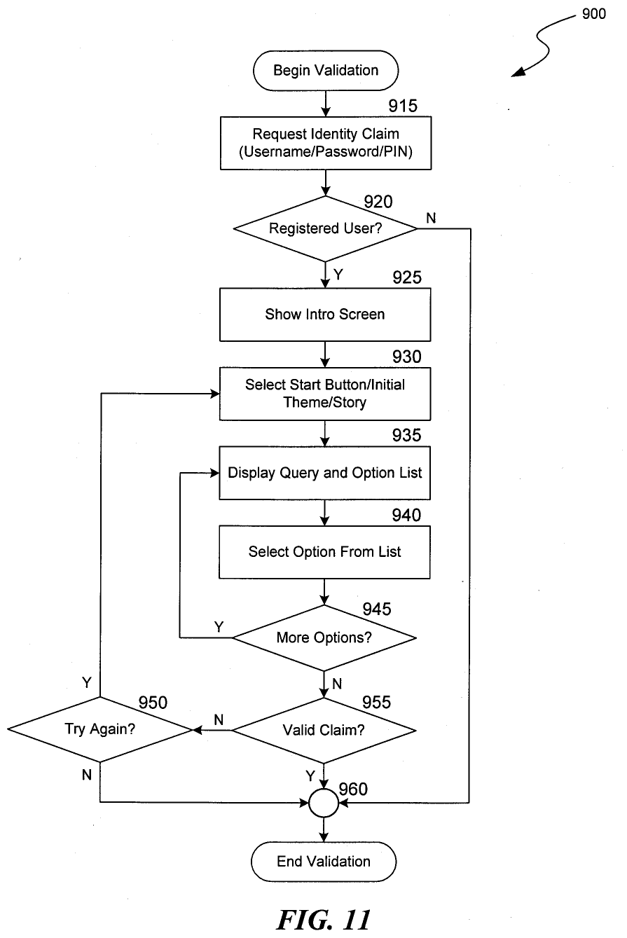

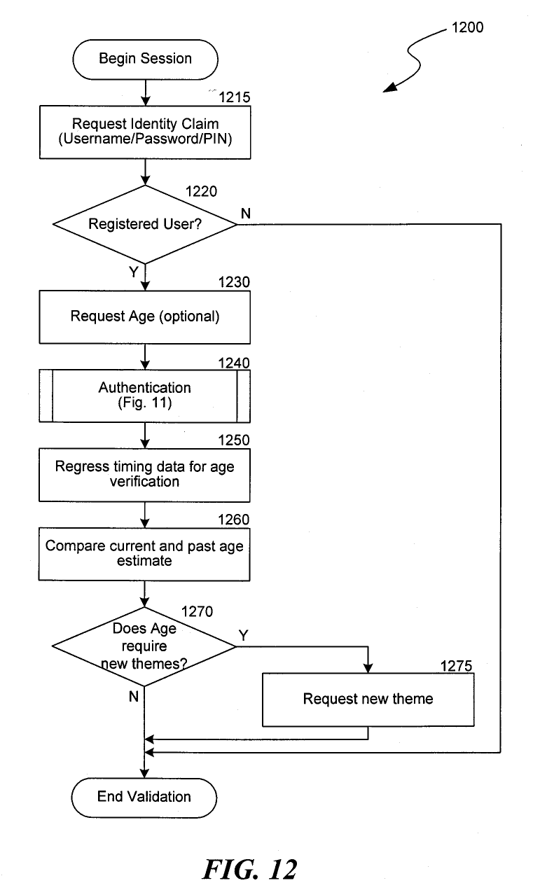

One embodiment of the current invention will be described in connection with the display screens shown in FIGS. 3A-10, and in the flow charts of FIGS. 11 and 12. During initialization, the user is asked to select one theme from a list of themes shown in a display (not shown). Once a theme is selected, the user progresses through a series of screens, completing the task by answering a question in each screen. The user is required to select each answer from a column of options, with each column applying to a particular detail about some aspect of the story. The columns may query about “who”, “what”, “where”, “when”, “why”, or “how”, as each relates to the theme.

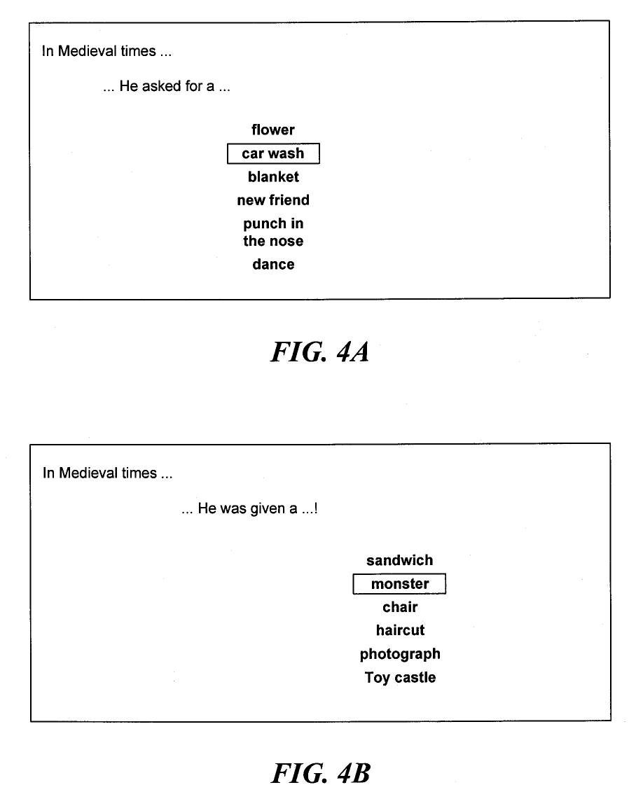

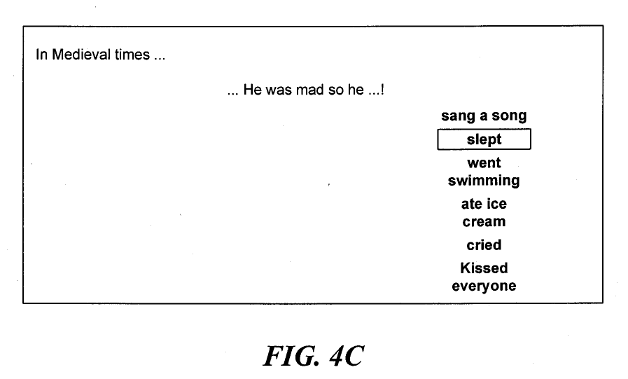

In the first example shown in FIGS. 3A-4C, the system presents a young user with an opening screen such as that shown in FIG. 3A that allows the user to select one of four themes, and associated instructions. After the user has selected, in this example, the “medieval” theme, then the system displays the screen of FIG. 3B, which asks the user to complete a sentence (“a king was talking to a . . . ”) where the user completes the sentence by selecting one of six options (in this case, “a shoemaker”). Thereafter, the user completes three more sentences by selecting one of six or more displayed choices, as shown in the screens of FIGS. 4A, 4B and 4C.

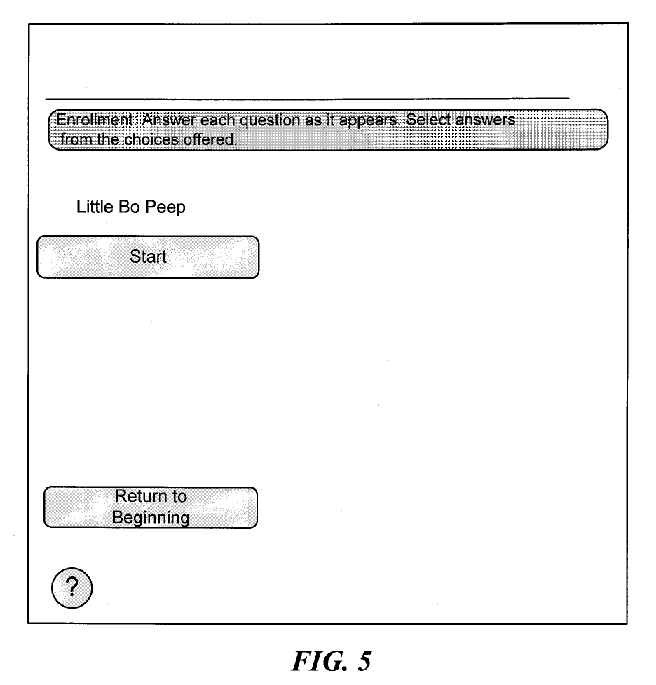

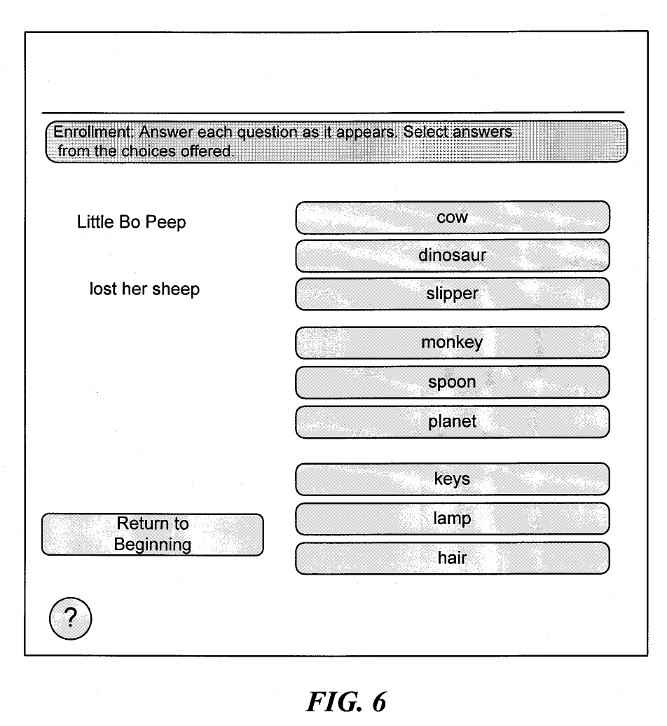

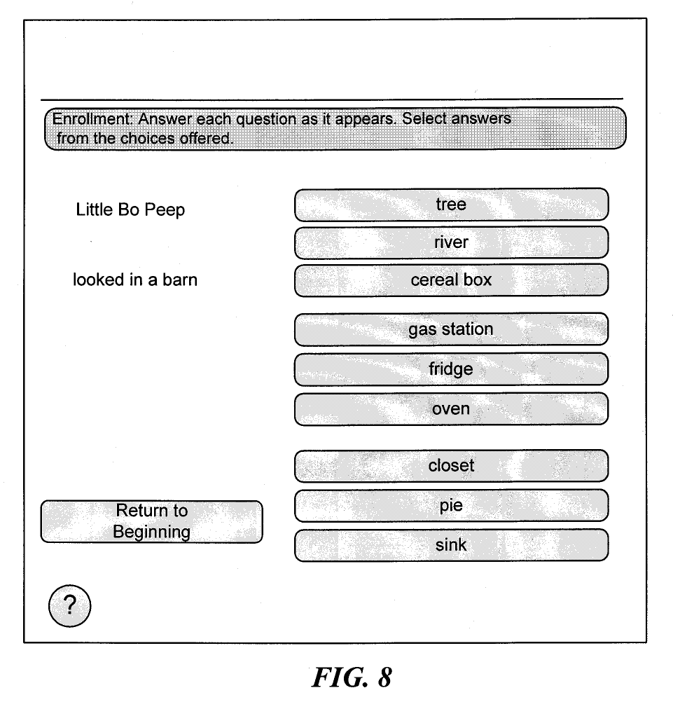

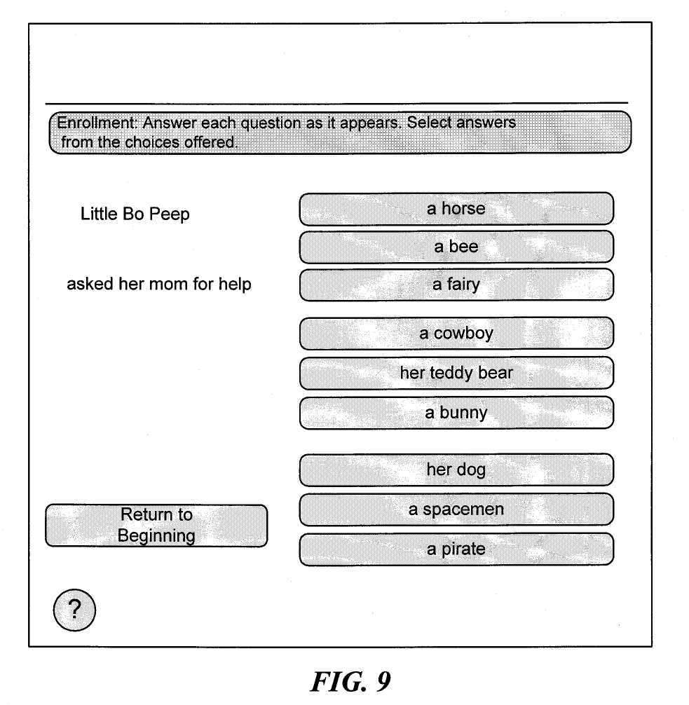

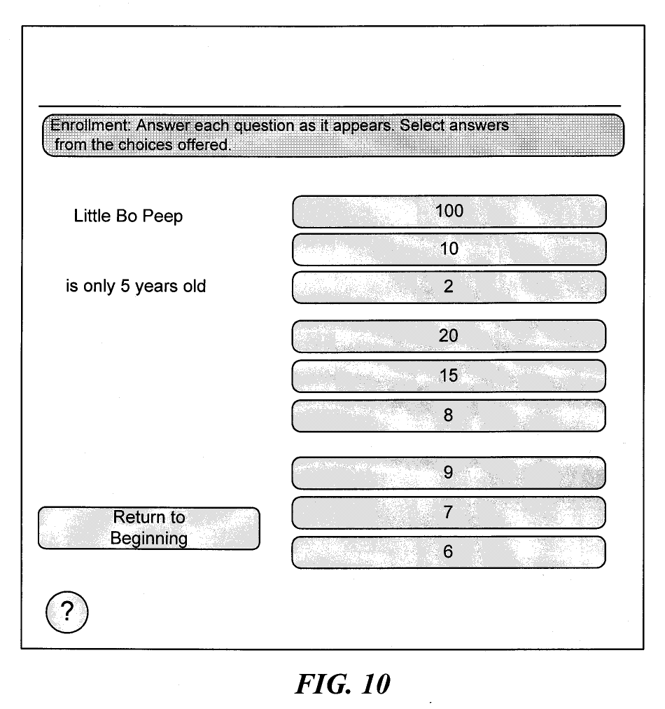

Another example is shown in FIGS. 5-10. In this example, a young user has selected “Little Bo Peep” from a list of themes, such as fairy tales, the user selects a start button (FIG. 5) and is presented with a series of options indicating a substitution for Little Bo Peep losing her sheep (FIG. 6). In this example, the user has selected “cow,” and the system then presents alternate options for Little Bo Peep showing her sadness. In this example, the user selects “singing” and the system presents options for where Little Bo Peep has looked (FIG. 8). In this example, the user has selected “tree” and the system them presents options for who Little Bo Peep asks for help (FIG. 9). In this example, the user has selected “a horse,” and the system finally presents options for how old Little Bo Peep is (FIG. 10). All of the user selections are saved and stored in the user profile to be later used during an authentication phase.

The system can present instructions to the user during each step. Users are encouraged to make their new story funny and interesting, thus increasing amusement and making it more memorable. The set of options are created to seem unusual, and their combinations will be perceived as exciting and captivating. Creativity not only produces a memorable story, but also an entertaining authentication experience.

FIG. 11 shows one embodiment of the authentication or validation phase, as a process 900. The process begins where the system receives a request from a user for authentication/validation, such as providing a user name, password, PIN, etc. (block 915). If the user is registered (block 920), then the system displays an introductory screen (block 925). The user selects a start button, initial theme, story or other initial element (block 930) and the system in response displays a question and list of options (block 935). The system receives user selection of one option from the displayed list (block 940), which is temporarily stored. The process cycles through blocks 935, 940 and 945 as screens of subsequent options are displayed and user input selecting options from the lists are received. After all lists of options have been displayed and one option from each list selected, the process compares the received options to those stored in the user profile to determine whether the authentication claim is valid (block 955), and if not, the user may be given one or more opportunities to try again (block 950). As noted herein, the system may not only compare received user selected options to those stored in the user profile, but also compare reaction times, mouse movement patterns, etc.

The same list of options (including the distracters and the correct answer) will be presented to the user on each authentication attempt, for at least three primary reasons. First, the real user will be familiar with both the correct response and the distracters, resulting in a faster search than that of a naive user or intruder; note that reaction times for option selection may be recorded, and the reaction times compared to others from earlier authentication attempts. Second, familiarity with the distracters requires the user to be able to discriminate and select the correct answer, as opposed to memorizing the exact response for purposes of recall; such recognition remains successful for a lifetime, whereas the ability to recall information quickly degrades—which also ensures that the user cannot transmit correct responses to others. Third, user performance will be enhanced to the degree that the testing conditions (recognition) matches those of the learning conditions (initiation), hence conserving as much detail as possible (including the distracters) facilitates performance for the real user, but not for an intruder.

Columns and option order may be rearranged or randomized for each authentication attempt. Changing the organization of the options or columns will affect intruders more than real users: Real user familiarity with correct as well as incorrect options will reduce search time relative to that of intruders. Other changes to the user interface may be provided that distract and increase reaction times for intruders, but provide significantly less distraction to the real user.

Referring to FIG. 12, an example of a routine 1200 for adjusting themes based on age and providing other age-related output begins in block 1215 where the routine requests some identity claim from the user, such as validating a user name, password, PIN, etc. If the user is registered (block 1220), then the routine may request an age of the user (block 1230). In block 1240, the routine invokes an authentication subroutine, such as that shown in FIG. 11. The routine then regresses timing data for age verification (block 1250) as noted above. For example, the system can analyze currently gathered user data (mouse movement, response times, etc.) and compare that to similar empirical data for users of various known ages to estimate the user's current age (or confirm that the input age is accurate based on comparison of input data to empirical data).

In block 1260, the routine compares the current regressed timing and past age data or other data stored in the user profile to determine an age estimate for the user. If the currently estimated age indicates that new themes should be provided (e.g., the user is outgrowing younger-based themes), then the routine requests new themes (block 1275) that can be provided to the user now or during a subsequent authentication session so as to enhance security, to improve the user's profile, and to provide an improved user experience. Thus, the system can periodically provide the user with new themes associated with older users when, for example, the routine determines the user has outgrown a particular age group or exceeded an age threshold. Alternatively, the system can compare the current date to an estimated age of the user stored in the user's profile, and if a certain time threshold is exceeded (e.g., greater than two years from the date that previous theme and response data was stored in the user profile), then the system again gathers some new test data for the user to be stored in the user's profile. Following blocks 1270 or 1275, the routine ends.

### VII. Conclusion

In general, the detailed description of embodiments of the invention is not intended to be exhaustive, or to limit the invention to the precise form disclosed above. While specific embodiments of, and examples for, the invention are described above for illustrative purposes, various equivalent modifications are possible within the scope of the invention, as those skilled in the relevant art will recognize. For example, while examples of the system allow users to select one of several categories that relate to fictional stories, fictional narratives, historical stories, fictional locations, fictional building constructs, or fictional characters, the system may employ any personalizing of a fictional, computer-generated construct, not just a story, building or animated character. Additionally, while processes are presented in a given order, alternative embodiments may perform routines having steps in a different order, and some processes may be deleted, moved, added, subdivided, combined, and/or modified. Each of these processes may be implemented in a variety of different ways. Also, while processes are at times shown as being performed in series, these processes may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference, including U.S. patents Ser. No. 11/161,116, filed Jul. 22, 2005, entitled “MEMORY BASED AUTHENTICATION SYSTEM”. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied as a means-plus-function claim under 35 U.S.C. § 112, sixth paragraph, other aspects may likewise be embodied as means-plus-function claims. Accordingly, the inventors reserve the right to add additional claims after filing the application to pursue such additional claim forms for other aspects of the invention.

I/We claim:

1. A method of authenticating a young user for access to a network, wherein the authentication method avoids the need for specialized authorization hardware, the method comprising:
in an initialization session:
presenting a user with multiple categories, wherein the multiple categories are not related to life events that the user may have experienced, but are related to at least one fictional story, or construction of at least one fictitious setting or character;
receiving a selection from the user of one of the multiple categories;
based on the selected category, presenting multiple statements or queries to the user, wherein each of the multiple statements or queries is related to the selected category and each of the multiple statements or queries is presented with multiple possible responses to the statement or query; and
for each of the multiple statements or queries, receiving from the user a response selected from the multiple possible responses, and storing the received response in a profile of the user; and
in an authentication session:
presenting the multiple statements or queries related to the selected category to the user, wherein each of the multiple statements or queries is presented with multiple possible responses to the query including the response to the statements or query received from the user in the initialization session;
for each of the multiple queries, receiving a response selected from the multiple possible responses from the user; and
authenticating the user if the received response to each of the multiple queries matches the response to each of the multiple queries stored in the profile of the user.

2. The method of claim 1, further comprising repeating the initialization session for two or more different selected categories for each user, and providing one set of multiple categories for younger users, and another set of multiple categories for older users, wherein the older users are not adults.

3. A computer-readable medium storing computer-executable instructions that provide an electronic access security method, the method comprising:
posing multiple categories to a user, wherein at least some categories do not relate to a personal event that the user may recall, but relate to at least one of multiple fictional stories, fictional narratives, historical stories, fictional locations, fictional building constructs, or fictional characters;
receiving a selection of one of the categories;
storing the received selection of the one category into a user authorization profile;
providing several questions or requests for the selected category, wherein each question or request includes multiple corresponding options;
receiving selected options for each of the several questions or requests; and
storing the received options in the user authorization profile, wherein the received selection and received options stored in the user authorization profile are associated with the user, and wherein each of the received options relate to the user's personalization of one of the multiple fictional stories, fictional narratives, fictional locations, fictional building constructs, or fictional characters, and
wherein the user authorization profile is used to later authentic the user.

4. The computer-readable medium of claim 3, further comprising: posing new multiple categories that do not include the stored received selection, and repeating the receiving a selection, storing the received selection, providing multiple options, providing several questions or requests, receiving selected options, and storing the received options.

5. The computer-readable medium of claim 3, further comprising: authenticating a user by providing a selected set of multiple categories, several questions or requests, and multiple corresponding options, and comparing received selections to the stored received selection and received options in the user authentication profile.

6. The computer-readable medium of claim 3 wherein the posing of multiple categories includes randomly selecting the multiple categories from a larger set of categories.

7. The computer-readable medium of claim 3, further comprising: receiving and storing a computer identification value, IP address, cursor movement patterns from computer input devices, keystroke generation patterns from keyboards, or thematic option patterns from chosen personal event categories.

8. The computer-readable medium of claim 3, further comprising: presenting information during authentication, including:
presenting a selected set of multiple categories, several selected questions or requests, and multiple corresponding options, wherein the selected set of multiple categories, several selected questions or requests, and wherein the multiple corresponding options presented include the stored received options with different but plausible alternative options.

9. The computer-readable medium of claim 3, further comprising:
receiving and storing response time values for the user, and
upon subsequent authentication, presenting several selected questions or requests with multiple corresponding options, and comparing times to respond to the several selected questions or requests to the stored response time values.

10. The computer-readable medium of claim 3 wherein the posing of multiple categories includes providing categories appropriate for older children as the user ages.

11. The computer-readable medium of claim 3 wherein the fictional stories are children's fairy tales, the fictional building constructs are at least one computer generated building, and the fictional characters are animated avatars.

12. The computer-readable medium of claim 3, further comprising: providing positive feedback to the user after receiving the selected options, wherein the feedback is configured to provide enjoyment to a young user.

13. The computer-readable medium of claim 3, further comprising:
receiving and storing response values for the user, wherein the response values include at least two of:
cursor movement patterns from computer input devices,
keystroke generation patterns from keyboards, and
response times for responding to several options or requests; and
comparing the stored response values to age regression parameters associated with known response values for users of various ages to estimate a mental age of the user.

14. The computer-readable medium of claim 3, further comprising:
estimating an age of the user based on gathered and stored user-input responses; and
providing an automatic notification to an external entity if the estimated age differs significantly from an age provided or inferred from input provided by the user.

15. A system to authenticate a user, the system comprising:
at least one user input portion;
at least one memory storing instructions;
at least one output portion; and
at least one processing portion coupled to the input and output portions, and coupled to the memory to execute the instructions stored in the memory, wherein the instructions configure the system to:
present a user via the output portion an interface for personalizing a displayed, fictional, system-generated construct;
receive via the input portion a user selection of an initial system-generated construct to personalize;
store in the memory the received selection of the initial system-generated construct to personalize;
provide via the output portion at least one question or request, wherein the question or request includes multiple corresponding options for personalizing the initial system-generated construct;
receive via the input portion at least one user-selected response for the question or request associated with the initial system-generated construct to personalize; and
store in the memory as a verification profile the received response for the question or request associated with the initial system-generated construct to personalize, wherein the stored initial system-generated construct to personalize and the received response are stored as being associated with the user, and wherein the received response relates to the user's personalization of the initial system-generated construct, and
wherein the user verification profile is used to later verify the user.

16. The system of claim 15 wherein the input portion includes an audio input device, wherein the output portion includes an audio output device, and wherein at least several questions or requests and multiple corresponding responses are presented audibly via the audio output device.

17. The system of claim 15 wherein the system is an automated teller machine (ATM), portable computer, or phone.

18. A security system, comprising:
means for providing multiple categories to a user, wherein at least one category does not relate to an experience to be recalled by the user, but relates to one of multiple fictional, computer-generated constructs;
means for receiving a selection of one of the categories;
means for storing the received selection of the one category into a user authorization profile;
means for providing several questions or requests for the one selected category, wherein each question or request includes multiple corresponding options;
means for receiving selected options for each of the several questions or requests; and
means for storing the received options of the one of the multiple options into the user authorization profile, wherein the stored received selection and received options are associated with the user, and wherein each of the received options relate to the user's personalization one of the fictional, computer-generated constructs, and
wherein the user authorization profile is used to later authentic the user.

19. The system of claim 18, further comprising: means for developing a stored set of responses to a user's selection of multiple different categories and corresponding selected options during different sessions.

20. The system of claim 18 wherein the means for providing multiple categories includes means for providing new categories to the user as the user ages, wherein the new categories are appropriate for older children.

21. The system of claim 18, further comprising:
means for estimating an age of the user based on gathered and stored user-input responses.

22. A computer-implementable security system, comprising:
at a first session, soliciting user input from a user under a first authentication process;
at the first session, storing input receipt from the user in an authentication profile, wherein the authentication profile is later used to authenticate the user;
determining that the user has aged beyond a set threshold;
at a second session later than the first session, soliciting newer user input based upon a second authentication process, wherein the second authentication model differs from the first authentication process, and wherein the first authentication process is specifically configured for younger users, while the second authentication process is specifically configured for older users; and
at the second session, updating the authentication profile based on the newer received user input.

23. The system of claim 22, wherein the first authentication process includes:
providing multiple categories to the user, where at least one of the categories does not relate to an experience to be recalled by the user, but relates to one or more fictional stories, fictional narratives, historical stories, fictional locations, fictional constructs, fictional characters; and,
receiving user-input that selects a category and answers several questions to provide personalizing information for the selected category.
